(19) United States
(12) Patent Application Publication
(10) Pub. No.: US 2015/0100444 A1
(43) Pub. Date: Apr. 9, 2015

(54) PORTABLE DEVICE FOR FINANCIAL TRANSACTIONS

(71) Applicant: Giorgio Fiorelli, Roma (IT)

(72) Inventor: Giorgio Fiorelli, Roma (IT)

(73) Assignee: FG S.R.L. AGENZIA FINANZIARIA, Roma (IT)

(21) Appl. No.: 14/343,718

(22) PCT Filed: Mar. 23, 2012
(86) PCT No.: PCT/IT2012/000081

§ 371 Date: Oct. 27, 2014

(30) Foreign Application Priority Data
Sep. 8, 2011 (IT) RM2011A000470

(51) Int. Cl. G06Q 20/20; G06Q 20/40

(52) U.S. Cl. CPC G06Q 20/206; G06Q 20/40145
USPC 705/18

(57) ABSTRACT

The invention relates to a portable device for financial transactions which can be used for safe payments and/or withdrawals of cash in real time and for other forms of credit and/or banking operations in general.

The present invention relates to a portable device for financial transactions which can be used for safe payments and/or withdrawals of cash in real time and for other forms of credit and/or banking operations in general.

In the technical sector of electronic economic transactions major efforts are being constantly made to develop systems of the so-called electronic wallet type where sums of money are withdrawn from an account at an approved bank and are used for the payment of goods or services instead of using cash.

Also known are economic transactions performed using “cashpoint card” means which require the keying-in of personal codes, as well as “credit card” means which require confirmation of the owner's signature and in some cases the presentation of an identity document. However, these known means may in some way be fraudulently reproduced or used by users other than the owner, should the said means be lost or stolen.

Also known are payment systems which use prepaid cards, with the disadvantage that they require topping up of the sum available whenever the funds run out and allow payments which are limited by the very nature of the card.

WO 01/35334 and U.S. Pat. No. 5,623,552 disclose credit cards which envisage reading of fingerprints for identification of the owner and authorization for money transfers.

US 2007/0220273 discloses a card for transactions which uses the input of biometric identification data and a wireless system for communicating an access code in the vicinity of a reader or a transaction system.

WO 2011/065867 discloses known solutions for high-security real-time economic transactions which use mobile phones.

However, although improvements are being continually made in order to increase the safety and practical nature of the known systems, with none of these systems possible to obtain the certainty that the user is effectively the legitimate owner of the credit means; moreover, with none of these known systems is it possible to have a single means or a single device which may be electronic and which simultaneously perform the functions of credit cards, cashpoint cards and cash.

Moreover, all the known systems which use means of the “badge” type, such as credit cards or cashpoint cards, are subject to dimensional requirements stipulated by the ISO 7810 standards such that they must have a well-defined maximum thickness which results in the necessary use—for example for the fingerprint recognition means—of thin mono-dimensional sensors which are less reliable than other types of sensors which have greater thicknesses and which cannot be used in these cards. In fact, as mentioned, in order to comply with the requirements of the ISO standards, the badge means must have a limited thickness so as to be able to bend or twist along all the axes without suffering damage.

These known systems therefore have the disadvantage that they envisage three separate means for the functions which are normally used in economic transactions, namely credit card, cashpoint card and cash card.

Moreover, these known means have limitations in terms of their thickness and are subject to damage, which may occur for example inside one's pocket or wallet, owing to their limited thickness.

Moreover, the type of recognition sensor of these known means must have a small thickness so that they can be used with badges means, with the result that they must be preferably of the mono-dimensional type, typically in the form of a single strip which is less reliable and difficult to read. In the aforementioned case other types of sensors with a greater thickness cannot be used.

In fact the known means do not ensure a bi-unique and non-reproducible correspondence between the legitimate owner of the credit means and the user thereof during a financial transaction of the economic type, since both the codes of the cashpoint cards and the signatures of the credit cards as well as wireless access operations, such as those described in the publication US 2007/022073, may be fraudulently intercepted, reproduced and used by non-authorized third parties.

A further disadvantage of the known devices consists in the impossibility of transferring sums of money between credit cards or cashpoint cards.

The object of the present invention is therefore to provide a portable device which allows an economic transaction to be performed safely in real time, so as to replace credit cards, cashpoint cards and cash with a single means, which portable device is able to be perform the detection of biometric data, such as fingerprints, store said data for subsequent use and authenticate in a certain manner the validity of each subsequent transaction request made by the user, confirming that the person performing the transaction is the legitimate owner of the credit means authorized for this purpose, the biometric data of said person being those stored, without having to key in codes or provide signatures or transmit data remotely and/or substantially without contact between a known transmitter and a known reader, allowing bank access directly without the use of codes or PINs.

Another object of the present invention is to perform the wireless communication between device and reader associated with the POS terminal preferably in a restricted and/or protected confined space so that the electromagnetic, optical or similar waves remain within this space and are not propagated within the environment.

A further object of the present invention is to provide a portable device which does not involve additional management costs in the case of use as cash.

A further object of the present invention is to provide a portable device which, in the event of loss or theft, cannot be used by third parties since the biometric data, such as one or more fingerprints, cannot be recognized.

A further object of the present invention is to provide a portable device which allows the transfer of sums of money between said portable devices.

Yet another object of the present invention is to ensure greater convenience, practicality of use and robustness compared to the known systems, including also credit cards which envisage recognition by means of fingerprints. In fact, according to the present invention, there are no limitations in terms of thickness, as in the case of conventional badges; consequently there is no risk of damage due to folding or the like, allowing the use of more sensitive and reliable sensors.

Another further object of the present invention is that of providing a device which is directly connected to the bank account and which, owing to its practical and immediate nature, may also be used to manage the payment of insignificant sums, such as that required to buy a coffee, bus ticket or newspaper, without additional costs, also managing cash in a different manner, since by being able to withdraw exact sums, the device can be used to make purchases down to a very small amount, without having to keep in one's pocket loose change which is often no longer considered or is lost or ignored for use as cash.

According to the present invention, the following is provided: a portable device which comprises essentially a biometric data reader, preferably any type of data sensor and in particular, for example a fingerprint sensor of preferably bi-dimensional capacitive, resistive, optical type or similar, a power supply unit suitable for supplying electric power to the portable device, clearly co-operating with an associated recharging system; circuits for reading and storing the biometric data, preferably for example fingerprints, as well as for subsequently identifying and validating said data, in order to associate in a certain manner the portable device according to the invention with the legitimate owner and allow the subsequent identification, recognition and validation of the said biometric data of the owner.

The portable device according to the present invention is also envisaged as being able to communicate wirelessly with a reader associated with a POS (Point of Sale) terminal of a retail outlet. This wireless communication is performed preferably in a confined space or in an extremely restricted and/or protected receiving seat so that the electromagnetic, optical or similar radiation for communication between the portable device and the reader associated with the POS terminal remains within the extremely small confined space and/or the restricted and protected seat and is not propagated within the environment, thus avoiding any possible interception and reproduction thereof.

“Confined space” in this context is understood as meaning a zone where the electromagnetic waves or the like which convey the signal between a portable device 100 according to the invention and an associated reader 110 remain within said confined space. Still in this connection the “confined space” may consist of both the volume formed between the surfaces for supporting the portable device 100 according to the invention and an associated reader 110 according to the invention and/or any type of suitable reader, and also be in the form of a surface or in the form of a receiving seat.

These and other characteristic features of the present invention will become clear from the detailed description which follows of a non-limiting example of a preferred embodiment of the portable device according to the invention with reference to the figures in the accompanying drawings in which:

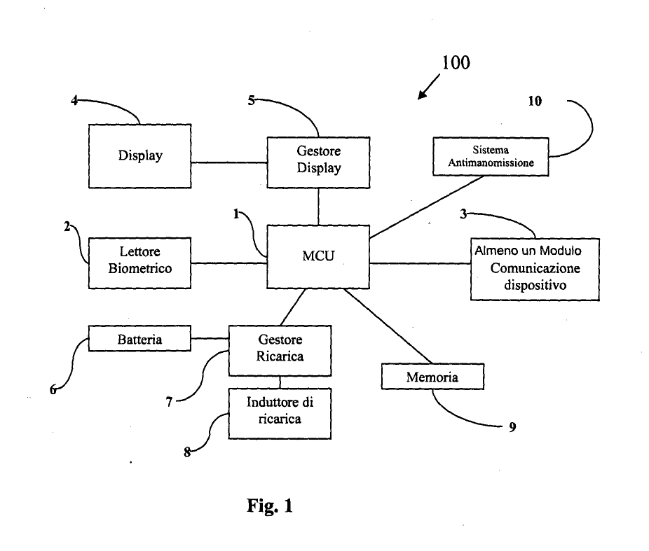

FIG. 1 shows the block diagram of the portable device according to the invention;

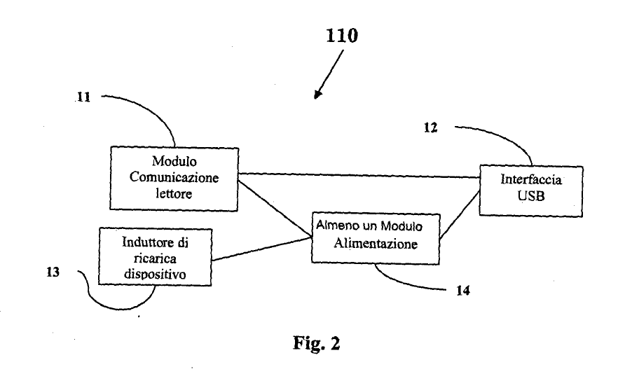

FIG. 2 shows the block diagram of the reader associated with the POS terminal and intended to communicate with the portable device according to the invention;

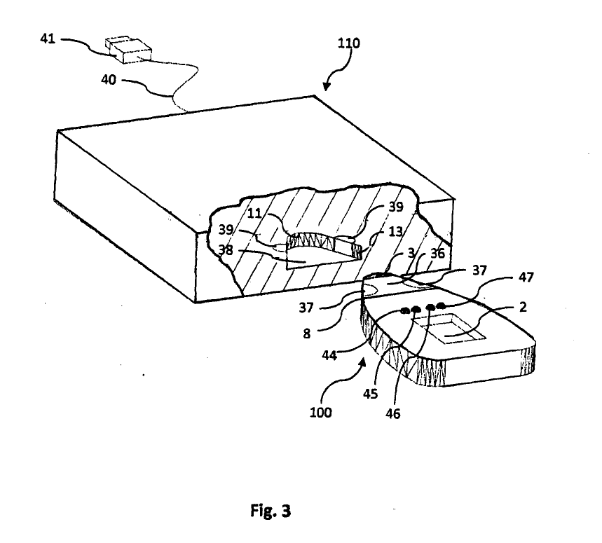

FIG. 3 shows, according to the invention, in a schematic manner opposite each other a portable device and a corresponding reader;

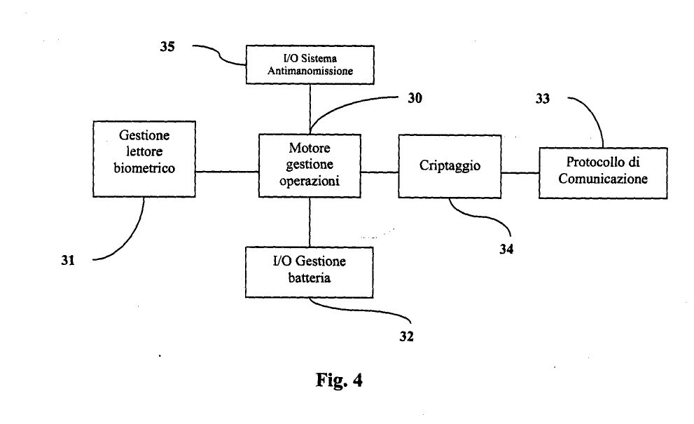

FIG. 4 shows in detail the block diagram of the program for operation of the microprocessor (MCU); and

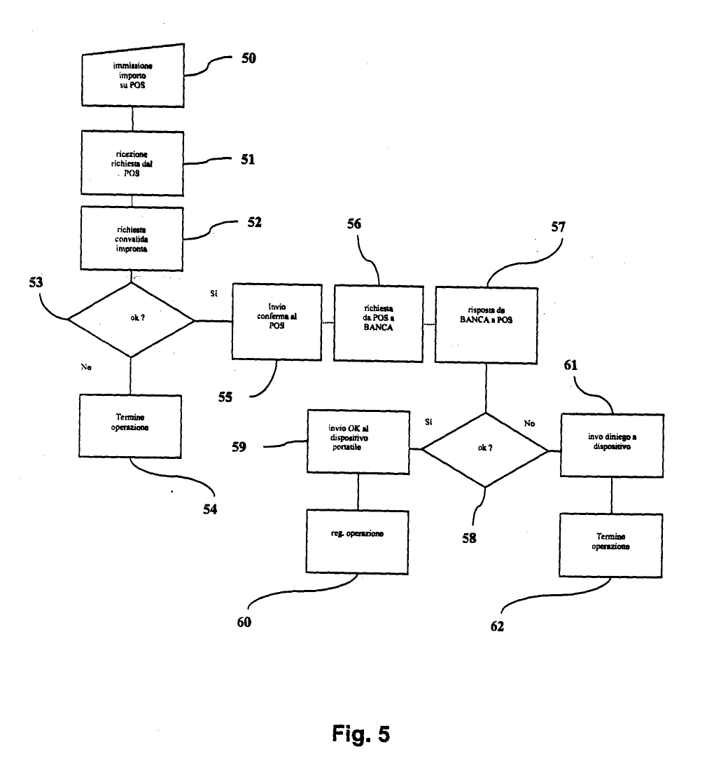

FIG. 5 shows the flow diagram of an example a transaction which uses, according to the invention, the portable device in combination with the corresponding reader associated with the POS.

With reference to FIGS. 1 and 2 these show the block diagram of a preferred embodiment of a portable device 100 according to the invention and an associated reader 110 communicating therewith.

In particular, the portable device 100 comprises a microprocessor unit or micro controller unit (MCU) 1 to which a biometric reader of any known type 2, at least one communication module 3 and optionally a display 4 with associated control circuits 5 are connected. A power supply battery 6 is also connected to the MCU 1 via a recharging controller 7 which controls a recharging means 8 of any suitable type, for example preferably of the inductive or similar type.

An optional additional memory 9 and optional anti-tamper system 10 may also be connected to the MCU 1.

The reader 110 shown in FIG. 2 comprises essentially a communication module 11 designed to communicate with the at least one communication module 3 of the portable device 100, an interface 12 preferably of the USB type and designed not to emit waves externally, associated with a POS terminal. A recharging device 13 of any suitable type, for example of the inductive type, connected by means of a power supply module 14 to the electricity mains, also forms an essential part of the reader 110.

More particularly, the device 100 is contained within a housing which has a form convenient for being used in a simple and ergonomic manner with one—either right or left—hand, having dimensions approximately the same as those, for example, of a cigarette lighter or an electronic car key.

This housing contains the components shown in the block diagram of FIG. 1 and in particular the MCU 1 which controls the entire portable device 100 and is activated by the positioning on the surface of the biometric reader 2 of at least one prechosen finger of the legitimate user who, exerting a more or less light pressure on the said surface, closes the circuit of any activation means providing power to the entire device 100. The activation means may consist, for example, of a microswitch which is positioned underneath the said biometric sensor 2 or a capacitive, resistive or proximity sensor which is provided in any convenient position of the device.

Activation of the device is confirmed by means of displaying of a suitable message on the display or by means of lighting up of one or more micro LEDs and/or an acoustic message or a vibration.

More particularly, the biometric reader 2 may be any fingerprint reader, preferably a sensor of preferably bi-dimensional capacitive, resistive, optical type or similar.

The biometric sensor 2 reads the fingerprint which is formed on its surface and informs the MCU 1, which carries out an initial qualitative evaluation thereof. Once the quality thereof has been approved, the MCU 1, via at least one of the device communication modules 3 connected to any one of the reader communication modules 11 according to FIG. 2, is able to receive the information for:
starting the operations for recording one or more fingerprints in the memory of the MCU 1 and/or in the additional memory 9 of the device and, once the entire recording operation has been completed, preventing the addition of and/or variation of the recorded data, if this reader is situated at the bank, or
checking that the fingerprint itself belongs to the legitimate user and that it is therefore already recorded in the memory of the MCU and/or in the additional memory 9, if this reader is connected to a POS.

The housing of the device also contains a recharging controller 7. This definition is understood as meaning preferably any means which is able to monitor periodically the charged state of the battery 6 of the portable device 100 and, if necessary, request rapid recharging thereof.

The operations described hitherto may be performed if the recharging controller 7 gives its consent, after checking that the voltage level present in the battery 6 is sufficient to power the necessary components of FIG. 1 for positive completion of the required operation. If this is not so, the recharging controller 7 signals the need for recharging and/or requests activation of a recharging means 8 for example preferably of the inductive type.

Protection of the integrity and accuracy of the biometric information contained in the memory of the MCU 1 and/or in any additional memory 9 (information which in the example of embodiment of the present invention consists for example of one or more fingerprints, i.e. up to ten fingerprints) is ensured by one or more anti-tamper systems 10 which, in the case of an attempt to perform forced opening of the portable device 100, instantaneously render the latter illegible and unusable.

A non-limiting example of the anti-tamper system 10 may envisage means able to send all the remaining voltage of the battery 6 to the terminals of the memory circuit of the MCU 1 and the additional memory 9, causing the immediate destruction thereof.

Clearly, it is possible to envisage a battery, for example of the lithium type, dedicated solely for the anti-tamper system 10 alone and never used for other purposes.

Alternatively, it is possible to envisage mechanical predefined-breakage means or chemical means such as phials containing a suitable corrosive substance.

The portable device according to the present invention may also envisage that one or more of the recorded fingerprints is used by the system to emit a silent alarm signal which the circuit concerned will use in a suitable manner, indicating forced or anomalous operation of the device.

FIGS. 1, 2 and in particular FIG. 3 show a preferred example of embodiment of the assembly consisting of the portable device 100 and the corresponding reader 110 to which it is to be connected. The mutual physical contact between the device (100) and the reader (110) is maintained by at least one magnetic means (37, 39) associated with either one of the device 100 or the reader 110 and interacting with a complementary engaging element (39, 37) provided on the reader 110 or on the portable device 100.

In an alternative embodiment not shown, the mutual contact between the device 100 and a corresponding reader of any type is obtained by simply by bringing into contact with the portable device 100 the surface of the restricted confined space of the reader associated with the POS.

Even more particularly, in the embodiment shown, the portable device 100 has a front end 36 provided with at least one magnetic means 37 preferably consisting of at least one pair of magnets 37, while the reader 110 has a receiving seat 38 which has internally at least one complementary magnetic engaging element 39 preferably consisting of at least one pair of magnets 39. When the front end 36 of the portable device 100 is inserted inside the receiving seat 38 of the reader 110, the magnets 37 and 39 respectively provided, as said, on the end 36 of the portable device 100 and inside the receiving seat 38 of the reader 110 in corresponding positions firmly keep the portable device 100 in contact with the reader 110 so that the respective device communication module 3 and reader communication module 11 remain in close physical contact and may exchange data without emitting waves of any type externally.

The symmetrical form of the device 100 could give rise to incorrect positioning of the said device inside the reader 110, for example, in the case where an optional communication unit for reception/transmission (RX TX) between the two elements, i.e. device and reader, is concerned. In fact, in order to comply with the need to maintain within an extremely confined space the exchange of information, the device 110 on the RX side must be placed in physical contact with the device 100 on the TX side, and vice versa. This result is obtained by providing in a suitable position within the receiving seat 38 of the reader 110 two magnets 39 which have facing polarities so as to come into contact with two similar magnets 37 arranged on the surface of the front end 36 of the device 100. The polarities of the magnets will ensure that correct positioning of the device 100 inside the reader 110 corresponds to secure locking together of the two elements, while incorrect positioning of the device 100 inside the reader 110 produces expulsion of the device from the reader owing to the magnetic repulsion effect.

Clearly, if the magnetic means 39 of the reader 110 are composed of electromagnets, the force of the latter may be adjusted so as to be maximum during use and practically zero at the end of the operations, for easy extraction of the device from the receiving seat 38.

Preferably, as shown in FIG. 3, for the sake of convenience of use the arrangement of the parts which form the device 100 and the corresponding reader 110 is such as to allow horizontal insertion of the device 100 inside the reader 110.

A different arrangement (not shown) of the parts may also be envisaged where the two elements, device 100 and reader 110, are arranged vertically; in this case, for example, the magnetic means 39 of the reader 110 interact with a complementary engaging element 37 made of ferromagnetic material arranged on the portable device 100, or vice versa, so as to allow the possibility of use with either the right hand or left hand, as required.

In the case where there is also a radiofrequency communications system, the latter may function preferably when the device 100 and the reader 110 are positioned in contact with one another, so that the confined space with separates them is close to zero and no electromagnetic radiation or the like may be emitted for ranges of more than one millimetre of distance or less. The correct positioning of the device 100 in contact with the surface of the reader or inside the receiving seat of the reader 110 and the correct recognition of the fingerprint are preferably signalled by suitable switching-on of at least one LED provided for this purpose, as will be explained more clearly hereinbelow.

The portable device 100 is provided, for example, with LEDs 44, 45, 46 and 47 which have specific functions and meanings:
the LED 44 indicates correct insertion or positioning of the device 100 inside, or in contact with, the reader 110 and, where appropriate, locking of the magnets 37, 39;
the LED 45 indicates that the fingerprint has been correctly stored;
the LED 46 indicates that the fingerprint has been recognized as valid and as therefore belonging to the legitimate user;
the LED 47 indicates that an error condition has occurred: the fingerprint is not recordable or has not been recognized as belonging to the correct user.

The reader 110, via the interface 12, preferably of the USB type and such as not to emit waves externally, associated electric cable 40 and connector 41, receives from the POS terminal or from the bank registration terminal suitable instructions as to what the device 100 must do:
perform payment when required by the sales point;
analyze the fingerprint detected on the biometric reader 2; and
record it in the memories of the MCU 1 and additional memory 9 of the same device 100.

The alerting of the user as to correct or incorrect positioning or operation may be associated with operation of LEDs and/or acoustic signals and/or vibrations which are known per se.

During this stage of the operations the reader 110 and the device 100 also keep, where required, the recharging inductors 13 and 8, respectively, in close contact with each other so that a correct power supply may be provided via them to the device 100 in the case where recharging of the device 100 is not sufficient to perform the required operations.

FIG. 4 shows in particular the operating program of the MCU 1 which comprises an operations control motor 30, which implements the logic functions for managing the biometric reader 31. The operations control motor 30 also implements the I/O logic functions for managing the battery 32. Furthermore the operations control motor 30 manages the communication protocol 33 with the reader 110, preferably via an encrypting routine 34.

The operations control motor 30 deals, finally, with the I/O of the anti-tamper system 35, where present.

More particularly, FIG. 4 shows the functions which are performed inside the MCU 1 under its direct control.

In particular, the operations control motor 30 cyclically monitors the channels for communication from and to:
the routine 34 for encrypting the communication protocol 33;
checks for any notifications from the anti-tamper system 35;
the routine 31 for management of the biometric reader 2;
checks the I/O signals of the controller of the battery 32.

Considering the time sequence of the operations, the latter are performed as follows:
activation of the device generated by introduction of the same inside the reader or in contact therewith;
communication by the reader to the operations control motor 30, via the communication protocol 33 and the encrypting routine 34, of the operations which are to be performed;
reading of the fingerprint or the fingerprints via the routine 31 for management of the biometric reader 2;
storage of the fingerprint or fingerprints (if at the bank for authorization of the device user);
recognition of the fingerprint or fingerprints for enabling execution of a financial operation;
in the I/O time delays of any one of the channels connected to the operations control motor 30, the control motor itself interrogates the routine for managing the battery 32 and/or the routine for managing the anti-tamper system 35.

FIG. 5 shows the flow diagram of a standard example of a financial transaction comprising the steps of:
50 introduction of the amount on the POS
51 reception of request from the POS
52 request for convalidation of the fingerprint
53 verification by the biometric reader control unit 31 that the fingerprint belongs to the legitimate owner of the portable device 100
54 termination of the operation if the fingerprint is not convalidated by the verification function 53
55 sending of confirmation to the POS if the fingerprint is convalidated
56 request from the POS to the payment bank
57 response of the bank to the POS
58 verification of the financial availability
59 if affirmative, sending of OK signal to portable device 100
60 recording of the operation
61 if negative, sending of reject signal to portable device 100
62 end of operation.

More particularly, the situation shown in the flow diagram according to FIG. 5 may refer to an operation for the purchase of goods or services to be performed at an agreed trading establishment via a bank which has adopted the system for use of the portable device 100.

Therefore, the operation (step 50) for introduction of the amount to be paid to the POS terminal occurs as the conclusion of the sales operation. At this point, the POS terminal asks the purchaser to insert the portable device 100 into the associated reading unit 110. Thereafter, the request (step 51) for payment by the POS terminal is received from the MCU 1 which requests in turn (step 52), for example via lighting up of a signalling LED, that the owner of the device 100 should allow verification, on the biometric reader 2, of one of his/her fingerprints previously recorded at the bank.

There are two possible outcomes for this verification operation (step 53):
the verification proves to be negative, resulting in termination of the operation (step 54)
the verification proves to be positive, resulting in sending of confirmation (step 55) that the owner's identity is valid

All this allows the POS terminal to send to the bank the request for availability of the sum relating to the sales operation in progress (step 56). In step 57, as well step 58, the response as to financial availability is provided by the bank to the POS terminal, namely, either:
negative (step 61), resulting directly in the end of the operation (step 62) or
positive (step 59), resulting in regular registration of the accounting operation and successful completion of the sales operation (step 60).

As regards that stated above, a preferred embodiment of the invention has been described, without however limiting it in any way to the characteristic features described. The persons skilled in the art will understand that, in the light of that made known here, modifications and numerous changes may be made without departing from the scope of the present invention as defined in the accompanying claims.

1. Portable device for financial transactions and/or banking operations in general, comprising a reader (2) of the biometric data of a legitimate owner; devices (1, 2, 9) for reading, decoding, storing and subsequent recognition of the biometric data, able to define a certain link between the device and the legitimate owner; means (37) for engaging with corresponding means inside a confined space or receiving seat (38) associated with a POS terminal; power supply and recharging means (6, 7, 8) able to supply electric power to the portable device.

2. Portable device according to claim 1, wherein the biometric data comprises at least one fingerprint.

3. Portable device according to claim 2, wherein the biometric data reader (2) is a fingerprint sensor of preferably bidimensional capacitive, resistive, optical type or similar.

4. Portable device according to claim 1, comprising a microcontroller unit MCU (1) to which the following are connected: a biometric reader (2); at least one communication module (3); a display (4) with associated control circuits (5); a power supply battery (6); and a recharging controller (7) which controls recharging means (8).

5. Portable device according to claim 1, wherein an additional memory (9) is connected to the MCU (1).

6. Portable device according to claim 4, wherein the said biometric data (2) is contained in the memory of the MCU (1) and/or in an additional memory (9).

7. Portable device according to claim 1, wherein the recharging means (8) comprised in the portable device (100) is of the inductive type.

8. Portable device according to claim 1, comprising an MCU (1) and wherein an anti-tamper system (10) is connected to the MCU (1).

9. Portable device according to claim 8, wherein the anti-tamper system (10) comprises means for sending all the remaining voltage of the power supply (6) to the terminals of the memory circuit of the MCU (1) and an additional memory (9), if present, causing the immediate destruction thereof.

10. Portable device according to claim 8, wherein the anti-tamper system comprises mechanical predefined-breakage means or chemical means.

11. Portable device according to claim 1, further comprising an anti-tamper system and a dedicated battery for the anti-tamper system (10) alone.

12. Portable device according to claim 1, comprising an MCU (1), which MCU (1) of the portable device (100) is associated with means for activating the power supply to the entire device (100), activated by the positioning on the surface of the biometric reader (2) of at least one predefined finger of the legitimate user.

13. Portable device according to claim 12, wherein said activation means comprises a microswitch positioned underneath the biometric sensor (2), namely a capacitive, resistive or proximity sensor provided in any convenient position of the device.

14. Portable device according to claim 1, comprising means for displaying switching-on of the device, said means comprising a display (4, 5) showing a suitable message, or one or more LEDs (44, 45, 46, 47) which are lit upon startup.

15. Portable device according to claim 1, wherein at least one item of biometric data is used for sending a silent alarm signal.

16. Portable device according to claim 1, further comprising a recharging controller (7) that gives its consent if the voltage level present in the power supply (6) is sufficient to power the necessary components of the device, indicating the need for recharging and/or requesting activation of recharging means (8) of the inductive type, if this is not the case.

17. Portable device according to claim 1, wherein the engaging means comprise at least one magnet (37).

18. Assembly comprised of a portable device (100) for financial transactions and a reader (110) connected to an interface (12) associated with a POS terminal, wherein the portable device is realized according to claim 1 and the reader (110) associated with a POS terminal comprises a confined space or receiving seat (38) for engagement with the portable device (100) and communication modules (11) able to communicate with the at least one communication module (3) of the portable device (100).

19. Assembly comprising portable device (100) and reader (110) according to claim 18, wherein said confined space has a small surface or said receiving seat (38) has a small and protected volume, said surface and seat being suitable for limiting dissipation externally of the communication waves sent between the portable device (100) arid the reader (110) and in that said interface (12) is of any type so as to prevent transmission of waves externally.

20. Assembly according to claim 19, wherein the mutual physical contact between the device (100) and the reader (110) is maintained by at least one magnetic means (37, 39) associated with either one or other of the device (100) or the reader (110) and interacting with a complementary engaging element (39, 37) provided on the reader (110) or on the portable device (100).

21. Assembly according to claim 20, wherein the at least one magnetic means (39) comprises an electromagnet, said complementary engaging element (37) being a magnet.

22. Assembly according to claim 20, wherein the at least one magnetic means (37, 39) comprises a magnet or a ferromagnetic material with corresponding complementary engaging element.

23. Assembly according to claim 18, wherein the reader (110) comprises a recharging device (13) which can be connected to the electrical network by means of a power supply module (14).

24. Assembly according to claim 18, wherein the recharging means (8, 13) provided in the portable device (100) and in the reader (110) are of the inductive type.

25. Assembly according to claim 18, further comprising one or more LEDs (44, 45, 46, 47), lighting up of which signals activation of the device (100), the correct positioning of the device on the surface of the restricted confined space or inside the restricted and protected receiving seat (38) of the reader (110), and the validity and/or recognition of the biometric information or an error condition.

26. Method for performing a standard financial transaction in real time, comprising:
the engagement of a portable device with a reader (110) associated with a POS terminal of a retail outlet, wherein the reader, to which is the portable device is engageable, comprises;
a confined space or receiving seat (38) for engagement with the portable device (100) and communication modules (11) able to communicate with at least one communication module (3) of the portable device (100)
and wherein the portable device that is engageable with the reader, comprises;
a reader (2) of the biometric data of a legitimate owner; devices (1, 2, 9) for reading, decoding, storing and subsequent recognition of the biometric data, able to define a certain link between the device and the legitimate owner; means (37) for engaging with corresponding means inside a confined space or receiving seat (38) associated with a POS terminal; power supply and recharging means (6, 7, 8) able to supply electric power to the portable device, and
the portable device (100) being configured to communicate wirelessly in real time with the reader, this communication taking place between the at least one device communication module 3 and the reader communication module 11 in an extremely restricted and protected confined space or receiving seat (38).

27. Method according to claim 26, comprising
the steps of:
50 introduction of the amount on the POS
51 reception of request from the POS
52 request fist convalidation of the at least one fingerprint
53 verification by the biometric reader control unit (31) that the fingerprint belongs to the legitimate owner of the portable device (100)
54 termination of the operation if the fingerprint is not convalidated by the verification function 53
55 sending of confirmation to the POS if the fingerprint is convalidated
56 request from the POS to the payment bank
57 response of the bank to the POS
58 verification of the financial availability
59 if affirmative, sending of OK signal to portable device 100
60 recording of the operation
61 if negative, sending of reject signal to portable device 100
62 end of operation.
